(19) United States
(12) Patent Application Publication
(10) Pub. No.: US 2026/0048835 A1
(43) Pub. Date: Feb. 19, 2026

(54) SYSTEMS, METHODS, AND DEVICES FOR AN AIRCRAFT CONTROL SYSTEM

(71) Applicant: Supernal, LLC, Irvine, CA (US)

(72) Inventors: Awais RAZA, Redondo Beach, CA (US); Martin Wesley SHUBERT, Tall Timbers, MD (US)

(73) Assignee: Supernal, LLC, Irvine, CA (US)

(21) Appl. No.: 19/124,485

(22) PCT Filed: Oct. 27, 2023
(86) PCT No.: PCT/US2023/078027

§ 371 Date: Apr. 25, 2025

Related U.S. Application Data
(60) Provisional application No. 63/381,509, filed on Oct. 28, 2022.

(51) Int. Cl. B64C 13/04; B64C 27/26; B64C 27/56; B64C 29/00

(52) U.S. Cl. CPC B64C 13/0421; B64C 27/26; B64C 27/56; B64C 29/00

(57) ABSTRACT

An aircraft includes a first inceptor assembly. The first inceptor assembly has a first base and a first control stick extending away from the first base, the first control stick defining a first longitudinal axis that extends through the first control stick, the first longitudinal axis forming a non-zero angle with a vertical direction. The aircraft includes a second inceptor assembly, the second inceptor assembly having a second base and a second control stick extending away from the second base, the second control stick defining a second longitudinal axis that extends through the second control stick and through the second base, the second longitudinal axis being generally aligned with a vertical direction.

### CROSS REFERENCE TO RELATED APPLICATIONS

This application is the U.S. national phase entry under 35 U.S. C. § 371 of International Application No. PCT/US2023/078027, filed Oct. 27, 2023, which claims priority on U.S. Provisional Application No. 63/381,509, filed Oct. 28, 2022, which is incorporated by reference herein in its entirety.

### TECHNICAL FIELD

The present disclosure relates to methods and systems for controlling an aircraft with an inceptor assembly.

### BACKGROUND OF THE INVENTION

Aircraft, including fixed wing aircraft and helicopters, are designed with control systems for adjusting multiple types of aircraft operations during flight. Conventions for control of different types of traditional aircraft have been established, these conventions providing consistency, helping to avoid confusion, and reducing the need for re-training. As an example, pushing an input forward with the left hand will typically add power in a fixed-wing aircraft. In a helicopter, an input device (e.g., a collective lever) is often pulled upwards to add power. These control systems, while helpful for their respective aircraft, can introduce confusion when applied to different types of aircraft, such as a hybrid aircraft and, in particular, to vertical take-off and landing (“VTOL”) aircraft capable of wing-borne flight.

Multiple control schemes have been proposed for use in hybrid aircraft. One configuration, for a VTOL aircraft, controls vertical trajectory during rotor-borne (low-speed) flight via a traditional helicopter downward-arcing thrust control (for rotor collective-pitch control). Longitudinal speed in this configuration is controlled through a traditional helicopter cyclic stick control. This trajectory relationship reverses during wing-borne (high-speed) flight, where traditional helicopter thrust control (for rotor collective-pitch control) manages airspeed and longitudinal stick control manages vertical trajectory through airplane-like controls. Such a reversal causes the operator to mentally transition the vertical and longitudinal axes when the aircraft moves from rotor-borne (low-speed) flight to wing-borne (high-speed) flight, leading to negative habit transfer issues and additional operator workload, especially during transitions.

Some VTOL aircraft, including some tiltrotor aircraft, utilize a horizontally-oriented thrust control to control the thrust axis, making it somewhat more intuitive for high-speed wing-borne flight. However, these configurations also suffer from habit transfer issues. For example, the horizontal orientation of the thrust control in such VTOL operations is 90 degrees offset from the vertical axis that it controls.

Accordingly, there remains a need for an aircraft control system that ensures an intuitive control system and/or controller, a reduction of pilot fatigue and workload, consistent flight control directives, and appropriate ergonomic support and comfort for the operator.

The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to embodiments consistent with the present disclosure, systems and methods are disclosed for controlling an aircraft with an inceptor assembly.

In accordance with an embodiment, an aircraft may have a first inceptor assembly. The first inceptor assembly may have a first base and a first control stick extending away from the first base, the first control stick defining a first longitudinal axis that extends through the first control stick, the first longitudinal axis forming a non-zero angle with a vertical direction. The aircraft may include a second inceptor assembly, the second inceptor assembly having a second base and a second control stick extending away from the second base, the second control stick defining a second longitudinal axis that extends through the second control stick and through the second base, the second longitudinal axis being generally aligned with a vertical direction.

In accordance with another embodiment, a system for controlling an aircraft may include a first inceptor assembly including a first control stick configured to receive a longitudinal input and a lateral input and a second inceptor assembly including a second control stick configured to receive a longitudinal input and a lateral input. The first inceptor may be at a fixed orientation such that, when the first control stick and the second control stick are each at neutral positions, the first control stick forms an angle with respect to a vertical direction that is different than an angle that the second control stick forms with the vertical direction.

In accordance with yet another embodiment, a method of controlling an aircraft may include receiving a first longitudinal input via a first inceptor assembly, actuating one or more control surfaces and/or one or more rotors to control a vertical movement of the aircraft in response to the first longitudinal input, receiving a first lateral input from via first inceptor assembly, and actuating the one or more control surfaces and/or the one or more rotors to control a yaw rotation of the aircraft in response to the first lateral input. The method may further include receiving a second longitudinal input from a second inceptor assembly and actuating the one or more control surfaces and/or the one or more rotors to control a movement of the aircraft in response to the second longitudinal input. The first longitudinal input may be generated when a first control stick of the first inceptor assembly is pushed forward and downward or pulled backward and upward.

### BRIEF DESCRIPTION OF THE DRAWINGS

The accompanying drawings, which are incorporated in and constitute a part of this specification, illustrate multiple embodiments of the presently disclosed subject matter and, together with the description, serve to explain the principles of the presently disclosed subject matter; and, furthermore, are not intended in any manner to limit the scope of the presently disclosed subject matter.

FIG. 1 illustrates an exemplary aircraft control system according to embodiments of the present disclosure.

FIG. 2 illustrates an exemplary inceptor assembly according to embodiments of the present disclosure.

FIG. 3 illustrates an exemplary aircraft control system according to some embodiments of the present disclosure.

FIG. 4 is a flow chart depicting an exemplary aircraft control method according to some embodiments of the present disclosure.

FIG. 5 illustrates exemplary mechanisms for adjusting one or more components of an inceptor assembly, according to some embodiments of the present disclosure.

### DETAILED DESCRIPTION OF EMBODIMENTS

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about,” “substantially,” and “approximately” are used to indicate a possible variation of ±10% in the stated value. In this disclosure, unless stated otherwise, any numeric value may include a possible variation of ±10% in the stated value.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section.

The disclosed flight control system includes an inceptor (e.g., a left-hand inceptor) to control aircraft motion for a low-speed flight mode, for a high-speed flight mode, and for transitioning between the two flight modes in a way that may be intuitive to the operator due to the orientation of the left-hand inceptor and consistent control directives and orientation. The inceptor may be used in a dual two-axis side stick system. Such a solution reduces operator workload and mental fatigue, provides for ergonomic support and comfort, and helps ensure that operation in all flight regimes is intuitive, ergonomic, and safe.

According to some embodiments, controls and control configurations in aircraft are disclosed herein that assist an operator to comfortably and intuitively control the aircraft throughout its operation. For example, control configurations enable operation of a speed or pitch of one or more rotors, and also operation of one or more control surfaces (e.g., elevators, rudders, ailerons, ruddervators, flaps, flaperons, or any other control surface known to one of ordinary skill in the art). Note that the term “aircraft” may encompass a large number of air vehicles including vertical take-off and landing (VTOL) aircraft (e.g., electrically-powered VTOL aircraft also referred to as “eVTOL” aircraft), airplanes, helicopters, aerostats, flight simulators, and spacecraft, among others. The above list does not limit what the term “aircraft”defines in terms of structure.

The proposed embodiments disclosed herein provide an aircraft control system with intuitive commands, a reduction of operator fatigue and workload, consistent flight control directives, and appropriate ergonomic support and comfort for the operator. Embodiments disclosed herein streamline controls and allow an operator to control an aircraft such as a VTOL in multiple stages of a flight, such as a take-off stage, a landing stage, a cruise stage, and during transitions between these stages, while realizing the above-described advantages. For a vertical take-off and landing (VTOL) aircraft in particular, at least some of the embodiments disclosed herein streamline controls and provide benefits for an aircraft during in a vertical thrust configuration (e.g., thrust-borne flight), a horizontal thrust configuration (e.g., wing-borne flight), and a transition period between the horizontal thrust and the vertical thrust configurations.

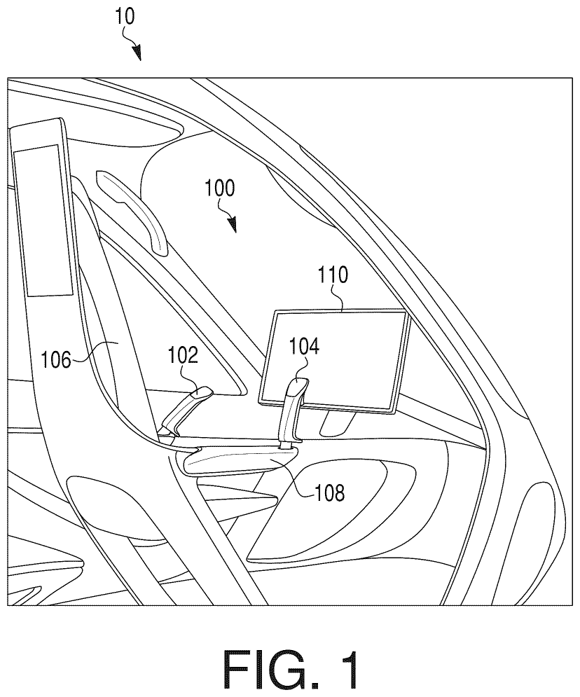

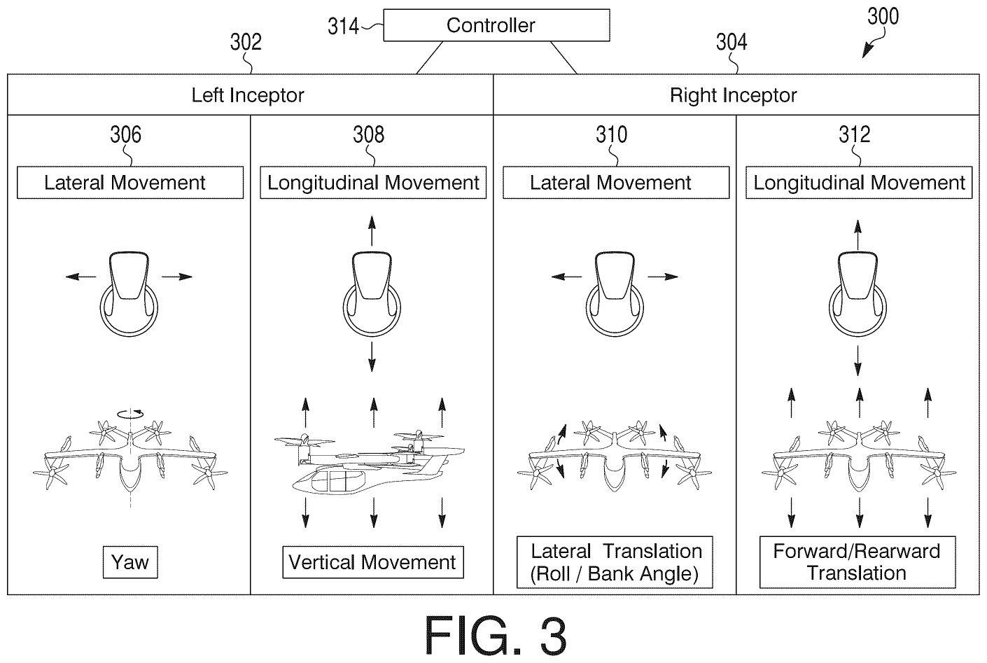

FIG. 1 illustrates an exemplary aircraft control system 100 for an aircraft 10 according to some embodiments of the present disclosure. Aircraft 10 may be a VTOL aircraft, such as an electrically-powered VTOL aircraft with a plurality of tiltrotors that support vertical takeoff and wing-borne cruising. An exemplary VTOL aircraft is shown in FIG. 3.

With reference to FIG. 1, control system 100 may include a multi-axis dual-inceptor flight control configuration having a left-hand inceptor 102 and a right-hand inceptor 104. An “inceptor,” as used herein is also referred to as an “inceptor assembly.” Control system 100 may include an operator seat 106 positioned generally between the left-hand inceptor 102 and the right-hand inceptor 104. As shown in FIG. 1, the operator may sit in the operator seat 106 within aircraft 10 with the ability to simultaneously reach both the left-hand inceptor 102 and the right-hand inceptor 104 in an ergonomically-supported manner. For example, the operator may rest an arm on an arm rest 108 that supports one of inceptors 102 and 104. One or both of inceptors 102 and 104 may include a fixed or adjustable wrist rest (not shown in FIG. 1) to provide an additional support surface in the area immediately behind the inceptor.

Control system 100 may also include a display 110, positioned within the operator's line of sight. Control system 100 may receive data from various aircraft sensors, flight management systems, and navigational databases, and may process and present the information to an operator in real time via display 110. Display 110 may present one or more flight parameters, such as attitude, airspeed, altitude, vertical speed, heading, and navigation information relevant to aircraft control. Display 110 may also include a heads-up display (HUD) that projects critical flight data onto a transparent surface, superimposing it within the operator's forward field of view. In embodiments where inceptor 102 and/or 104 is adjustable, display 110 may be configured to display the current angular setting for inceptors 102 and 104 and facilitate a change in these orientations by the operator.

Left-hand inceptor 102 and right-hand inceptor 104 may each receive longitudinal inputs (e.g., forward/backward movements from an operator's perspective) and lateral inputs (e.g., left-right movements from an operator's perspective) wherein the operator may direct the left-hand inceptor 102 and the right-hand inceptor 104 accordingly. Thus, the operator may utilize each of the left-hand inceptor 102 and the right-hand inceptor 104 to control an aircraft (e.g., VTOL aircraft) over an entire flight envelope. Such a flight envelope may include rotor-borne flight (e.g., takeoff and landing), wing-borne flight (e.g., cruising), and transition points between the two flight configurations. For example, control inputs may remain the same or substantially the same in different flight configurations (e.g., rotor-borne flight, wing-borne flight, and transition between rotor-borne and wing-borne flight).

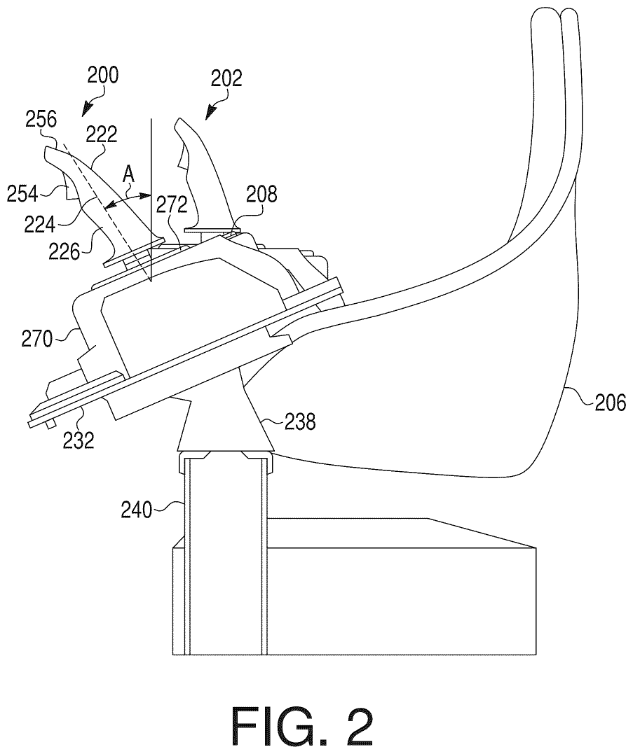

Inceptor 102 may be to the left of seat 106 from the operator's perspective, when seated, and may therefore be referred to as a left-hand inceptor. Inceptor 104 may be to the right of seat 106, forming a right-hand inceptor. Left-hand inceptor 102 may be angled forward, away from seat 106, and secured at this position so as to form a non-zero angle “A” (FIG. 2), angle “A” being measured from a longitudinal axis of inceptor 102 to a vertical direction. Angle “A” may be formed by the angular distance between a longitudinal axis of the inceptor and the vertical direction, as described below.

As used herein, a “vertical direction” is a direction that is normal to a floor surface to which seat 106 is connected when aircraft 10 is stationary on level ground and/or a direction opposite to the direction of gravity when aircraft 10 is stationary on level ground. As used herein, a “non-zero angle” of an inceptor is an angle of at least 10 degrees, as measured by a longitudinal axis defined by the inceptor and the vertical direction. The non-zero angle is measured when no input is provided to the inceptor and the inceptor is in a corresponding neutral position. A longitudinal axis 224 of the inceptor In some embodiments, longitudinal axis 224 extends through at least a portion of a control stick of the inceptor and a location where the control connects to (e.g., joins) a base of the inceptor.

As indicated above, left-hand inceptor 102 may be orientated at non-zero angle “A”. Angle “A” may be at least about 20 degrees and less than about 90 degrees. In particular, angle “A” may be at least about 30 degrees and less than about 80 degrees, or at least about 40 degrees and less than about 70 degrees. If desired, angle “A” may be 90 degrees when left-hand inceptor 102 is generally aligned with a horizontal direction.

While left-hand inceptor 102 may be angled forward, in at least some embodiments right-hand inceptor 104 is not angled (e.g., is aligned, within less than 10 degrees, with the vertical direction as measured from the longitudinal axis of the inceptor and the vertical direction). Inceptor 102 and inceptor 104 may be fixed in these positions, such that, when no control inputs are provided, inceptors 102 and 104 are always at different vertical orientations. In the illustrated embodiments, inceptor 102 may be offset from a vertical direction, and in at least some embodiments, from inceptor 104, by an angle “A” (FIG. 2). Angle “A” may be about 15 degrees, about 30 degrees, or about 45 degrees, with additional examples being described below. Inceptors 102 and 104 may be positioned at different angles, such that longitudinal motion of an inceptor (e.g., left-hand inceptor 102) is at least partially aligned with vertical motion of aircraft 10, while lateral motion of the inceptor is at least partially aligned with directional movement and with the movement of aircraft 10 about a yaw axis.

Although the configuration shown in FIG. 1 includes armrests 108 and left and right inceptors 102 and 104 that extend from a respective armrest 108, other configurations are contemplated. For example, inceptor 102 and/or inceptor 104 may be located on a console in front of seat 106. Inceptor 102 and/or inceptor 104 may be located on a cockpit surface such as a wall to the left or to the right of seat 106. Inceptor 102 and/or inceptor 104 may be connected to a floor of the aircraft and may extend upwards to locations adjacent to seat 106 (e.g., to provide the ability to remove seat 106 without replacing inceptors 102 and 104).

Inceptor 102 and inceptor 104 may be used simultaneously (e.g., by an operator's left hand and right hand) to control different flight axes of pitch, yaw, and roll, as well as nacelle angle, and accordingly, the flight control path, as described below. To facilitate intuitive control of the aircraft, the inceptor for controlling vertical movement (e.g., increasing and decreasing altitude) may be placed at angle “A”, whether this inceptor is left-hand inceptor 102 or right-hand inceptor 104.

FIG. 2 is a side view illustrating an exemplary inceptor assembly 200 to the left of seat 206 according to some embodiments of the present disclosure. A second inceptor assembly 202 is shown to the right of seat 206. Inceptor assembly 200 may correspond to left-hand inceptor 102, while inceptor assembly 202 corresponds to right-hand inceptor 104. Inceptor assembly 200 may include an arm rest 208, a wrist rest (not shown in FIG. 2), a base 270, an upper surface 272, a control stick 222 protruding through an opening in surface 272 and having a hand-grip 226, a support frame 238, a support plate 232, and a base support 240.

As shown in FIG. 2, inceptor assembly 200 and base 270 may form a housing connected to additional support members of the aircraft. Base 270 and other components of assembly 200 may be secured to aircraft 10 such that base 270, support plate 232, support frame 238, and base support 240 are fixed in place (e.g., not adjustable and removable only to perform maintenance or repair).

Arm rest 208 of inceptor assembly 200 may fixedly attached to plate 232 and support frame 238 via base 270. However, in at least some configurations, arm rest 208 is movably connected to support frame 238 of inceptor assembly 200. Arm rest 208 may also be a part of or attached to a seat (e.g., seat 206), console, or other structure in the proximity of a control stick 222. An upper surface of arm rest 208 may include a cushion or other resilient surface that absorbs impacts and adds comfort for an operator.

Arm rest 208 may comfortably and ergonomically support the operator's arm during flight control, thereby stabilizing the hand, preventing shifting of the hand, reducing arm fatigue, and maintaining biomechanical health of the arm and wrist joint of the operator. For example, when inceptor assembly 200 is fixed at an orientation that defines angle “A”, an upper surface of arm rest 208 may be fixed at the same angle. While at this fixed angle “A”, arm rest 208 may support the operator's arm so as to isolate the arm from aircraft accelerations and vibrations. This advantageously reduce aircraft pilot coupling or pilot-induced oscillation. In stabilizing the hand during flight control, arm rest 208 provides the ability to make smaller (e.g., more minute) and precise motions when providing inputs via inceptor assembly 200 and the operator's hand and arm may not move as much or as far. In other words, control stick 222 may be configured to be more sensitive to smaller movements, in part due to arm rest 208.

A wrist rest (not shown in FIG. 2) may be connected to or incorporated within base 270 and attached to support frame 238 and base support 240 via base 270. If desired, the wrist rest may be vertically translated to adjust the wrist rest while the wrist rest is angled in the same manner as arm rest 208.

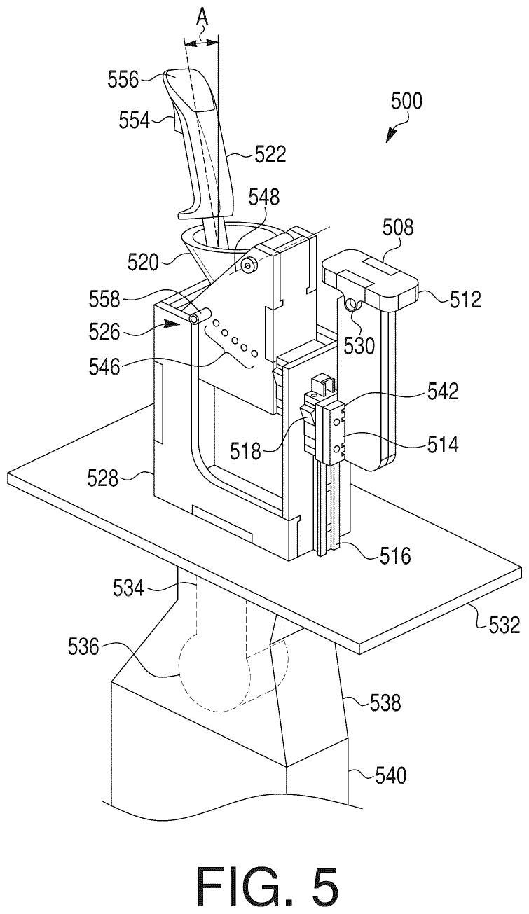

Inceptor assembly 200 may further include a control stick (e.g., lever or stick) 222 configured to receive longitudinal inputs (e.g., forward and backward movements that include a downward component or an upward component, respectively) and lateral inputs (e.g., left-right movements) for flight control. Control stick 222 may be movably connected to a support member (e.g., support member 520; FIG. 5).

Control stick 222 may include a hand-grip 226 that defines a surface configured to receive a palm of an operator's hand. Hand-grip 226 may define longitudinal axis 224 of inceptor assembly 200. For example, hand-grip 226 may extend away from base 270 such that longitudinal axis 224 passes through the center of longitudinal axis 224 and also away from base 270. While not required, longitudinal axis 224 may pass through base 270.

An ergonomic handle may be formed at the distal end of control stick 222. The handle may include one or more input devices, such as buttons, triggers, pads, switches, or joysticks. The input devices may be used to control internal or external features of aircraft 10 and may be used during flight for additional flight controls. By way of example, a handle of control stick 222 may include a trigger 254 and a touch input 256 (e.g., a capacitive touch surface). Touch input 256 may be a screen configured to display controls and receive touch inputs from an operator to control various systems of the aircraft.

Although not shown in FIG. 2, control stick 222 may include one or more hold molds, a hardware detent (e.g., mechanical or magnetic), and a software detent so as to maintain consistent aircraft operation when an operator is not providing input or providing minimal input. The hold molds may hold control stick 222 at angle “A” or an angle other than angle “A” when input is not provided from an operator. The hardware detent may hold control stick 222 at angle “A” or another angle when force is not input by an operator or does not reach a threshold force. A software detent may be operated using one or more electronically-controlled actuators connected to control stick 222 to maintain a desired position with respect to angle “A” when no operator input is provided. The software detent may be based on a measured input from an operator (e.g., a threshold position change or a threshold input force). Hold molds, hardware detents, and software detents may allow for hands-off control and/or to prevent inadvertent operator input.

FIG. 3 illustrates an exemplary aircraft control system 300, according to embodiments of the present disclosure. Control system 300 may include a multi-axis dual-inceptor flight control configuration including control of the appropriate flight axes of pitch, yaw. Control system 300 may include a left-hand inceptor 302 (e.g., left-hand inceptor 102, inceptor assembly 200), a right-hand inceptor 304 (e.g., right-hand inceptor 104, inceptor assembly 202), and controller 314.

Left-hand inceptor 302 of control system 300 may receive one or more longitudinal inputs 308 (e.g., forward/backward movements) and one or more lateral inputs 306 (e.g., left-right movements). In embodiments where left-hand inceptor 302 has a neutral position that forms a non-zero angle “A” (e.g., FIG. 2), forward movements of the control stick may be both forward and downward, while backward movements are both rearward and upward, the downward and upward components of the movement being larger with larger values of angle “A”.

As shown in FIG. 3, an operator may utilize longitudinal inputs 308 of left-hand inceptor 302 to provide an overall vertical adjustment (e.g., adjustment in altitude) to aircraft 10. Due to inceptor 302 being at angle “A”, part of the movement of inceptor 302 matches the requested vertical movement of the aircraft (e.g., a forward and downward movement of inceptor 302 causes descent of aircraft 10). In some examples, most of the motion of inceptor 302 may match the vertical motion of the aircraft (e.g., examples where angle “A” is greater than 45 degrees). In other examples, less than half of the movement of inceptor 302 may match the corresponding vertical motion.

Lateral inputs 306 of the controller of left-hand inceptor 302 may adjust and/or control the yaw or the heading of the aircraft accordingly. In some embodiments, yaw and heading may be controlled or adjusted together (e.g., for a coordinated turn of an aircraft). Left-hand inceptor 302 may translate mechanical motion inputs (e.g., lateral movement 306 and/or longitudinal movement 308) into electrical signals, and may transmit the electrical signals to controller 314 via a wired or a wireless connection.

Right-hand inceptor 304 of control system 300 may also receive one or more longitudinal inputs 312 (e.g., forward/backward movements) and lateral inputs 310 (e.g., left-right movements) wherein the operator may direct right-hand inceptor 304 accordingly. As shown in FIG. 3, the operator may utilize the longitudinal inputs 312 of right-hand inceptor 304 to control and/or provide forward and rearward translation of the aircraft.

Forward and rearward translation may include changes in a pitch angle of aircraft 10. For example, a forward translation may include manipulating one or more control surfaces and/or rotors such as proprotors of the aircraft to accelerate or decelerate the aircraft in the longitudinal direction. A forward translation may include shifting the nose of the aircraft 10 downward, and shifting the tail of aircraft 10 upward. A rearward translation may include shifting the nose of aircraft 10 upward and the tail of aircraft 10 downward. Additionally, in the example of a tilt-rotor aircraft 10, nacelle movement may result from adjustments to longitudinal movement 308.

Furthermore, lateral inputs 310 of right-hand inceptor 304 may control and/or provide lateral translation of the aircraft. A lateral translation of aircraft 10 may include changes in a roll angle or bank angle of aircraft 10. For example, a lateral translation to the right may include rolling to the right (e.g., manipulating one or more control surfaces and/or rotors to lower the right wing and raise the left wing of the aircraft), resulting in lateral translation when aircraft 10 is in rotor-borne (low-speed flight) and a change in bank angle when aircraft 10 is in wing-borne (high-speed) flight. Right-hand inceptor 304 may translate mechanical motion inputs (e.g., lateral movement 310 and/or longitudinal movement 312) into electrical signals, and may transmit the electrical signals to controller 314 via a wired or a wireless connection.

Controller 314 may receive signals from left-hand inceptor 302 and right-hand inceptor 304. Controller 314 may include one or more processors that determine which control surfaces and/or rotors may be actuated to cause the desired movement of the aircraft. By way of example, during wing-borne flight, upon receiving a signal indicating lateral movement 310 from right-hand inceptor 304, controller 314 may instruct one or more ailerons to be actuated, causing the aircraft to roll and be translated laterally.

The orientation, structure, and functionality of controls for each of the left-hand inceptor 302 and the right-hand inceptor 304 may be the same whether the aircraft is experiencing rotor-borne flight, wing-borne flight, or a transition between rotor-borne and wing-borne flight. In other words, by way of example, longitudinal movements 308 control upward and downward motion whether aircraft 10 is in a rotor-borne flight mode, a wing-borne flight mode, or a transition between the two flight modes. This control scheme is reinforced by placing left-hand inceptor 302 at a non-zero angle. Accordingly, control system 300 may be intuitive for the operator without regard to the current flight mode. Control system 300 provides for a clear delineation of control directives in a certain and consistent manner thereby allowing for more intuitive flight control, reduced operator workload and mental fatigue, and diminished negative habit accumulation and transfer.

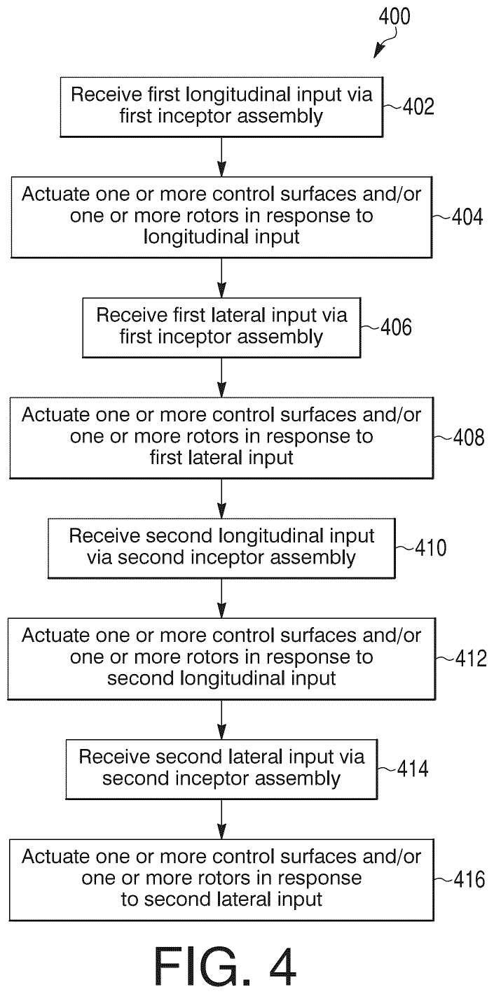

FIG. 4 is a flow chart depicting an exemplary aircraft control method 400 according to embodiments of the present disclosure. Method 400 may include one or more of steps 402-416. Step 402 may include receiving a first longitudinal input with controller 314 via a first (e.g., a left-hand) inceptor assembly (e.g., inceptor assembly 102, 200). The longitudinal input may be received through a control stick of the first inceptor assembly, such as control stick 222 of FIG. 2, and may be generated by a sensor that detects physical movement of control stick 222. While referred to as a “longitudinal” movement, the movement includes a vertical (upward or downward) movement according to angle “A”, as described above. A forward movement may be achieved when the first inceptor assembly is pushed forward and downward. A rearward or backward movement may be achieved when the first inceptor assembly is pulled backward and upward.

Step 404 may include actuating one or more control surfaces and/or one or more rotors of aircraft 10 to control a vertical movement of the aircraft in response to the longitudinal input of step 402, such as shown in FIG. 3 with longitudinal inputs 308 controlling a vertical movement of the aircraft.

Step 406 may include receiving a lateral input with controller 314 via the first inceptor assembly. Step 408 may include actuating the control surfaces and/or rotors to control a yaw rotation of the aircraft in response to the lateral input of step 406.

Step 410 may include receiving a longitudinal input with controller 314 via a second (e.g., a right-hand) inceptor assembly (e.g., inceptor assembly 104, 202). At step 412, method 400 may include actuating the one or more control surfaces and/or the one or more rotors to control a forward or rearward movement (e.g., translation) of aircraft 10 in response to the longitudinal input from the second inceptor assembly. The vertical component of the movement of the control stick of the second inceptor assembly in step 410 may be lesser in magnitude than the vertical component of the movement of the control stick of the first inceptor assembly in step 402, even when the control sticks of the first and second inceptor are moved by the same distance. For example, step 410 may be performed without pushing the control stick of the second inceptor assembly downward and without pulling the control stick of the second inceptor assembly upward, as the control stick of the second inceptor assemblies does not form a non-zero angle with the vertical direction.

Step 414 may include receiving a lateral input with controller 314 via the second inceptor assembly. Step 416 may include actuating the one or more control surfaces and/or the one or more rotors to control a lateral movement (e.g., translation) of aircraft 10 in response to the lateral input from the second inceptor assembly.

FIG. 5 illustrates an internal configuration of an inceptor assembly 500, in an embodiment where inceptor assembly 500 is adjustable, rather than fixed in place. Inceptor assembly 500 may correspond to inceptor assemblies 102, 104, 200, and/or 202, and may be used as the first inceptor assembly, the second inceptor assembly, or both inceptor assemblies, of method 400. Inceptor assembly 500 may include a support frame 538, a base support 540, a trigger 554, and a touch input 556, these features corresponding to support frame 238, base support 240, trigger 254, and touch input 256, respectively.

Adjustable components of inceptor assembly 500 may include one or more of support member 520, arm rest 508, and support plate 532, as described below. While inceptor assembly 500 is described herein as being adjustable, as understood, each element of assembly 500 may be in a fixed position and incorporated in inceptor assembly 102, 104, 200 and/or 202.

As shown in FIG. 5, arm rest 508 may include a pad 512. Pad 512 may be rotated (e.g., tilted) around a hinge 530, either manually or automatically, to place control stick 522 and pad 512 at the same angle “A” or at different angles. The adjustments of arm rest 508 may be automatic or autonomous (e.g., based on a flight condition, such as pitch angle or angle of attack of aircraft 10).

Inceptor assembly 500 may further include a linear motion device 542 (e.g., a linear mechanism such as a linear actuator) that adjusts the height of arm rest 508. Linear motion device 542 may be manually operated, or electronically and/or autonomously actuated. Linear motion device 542 may include a motor 514, a rail 516, and an actuator 518 (e.g., a button or switch) for causing motor 514 to move arm rest 508 along rail 516. The actuator or linear mechanism may further include an automatic or manual emergency release to the full down position for emergency egress from the operator seat. In some embodiments, linear motion device 542 may include a hydraulic or pneumatic cylinder to produce linear motion, whether actuated manually or automatically.

When angle “A” is adjustable, a mechanism may be provided to adjust control stick 522 without altering the angle defined by other components of assembly 500. As one example, support member 520 is movable via an adjustment mechanism 526, this movement changing angle “A”. As shown in FIG. 3, adjustment mechanism 526 may include a pin 558 that is placed in one of a plurality of apertures 546 to tilt support member 520 and control stick 522 together. For example, an operator may remove pin 558 from a particular aperture 546, rotate control stick 522 and support member 520 about axis 548, and insert pin 558 in a different aperture 546. If desired, a locking mechanism or other device may be used to prevent movement or removal of this pin except during adjustment (e.g., when the aircraft is stationary). Other methods to adjust an angle of one or more components of inceptor assembly 500 may be used, such as clamping, retractable pins biased towards being engaged, indents, receptacles, or linear or rotational actuators that can move and/or lock at a desired position.

In some adjustable configurations, support plate 532 may be adjustable together with a support frame 528 and control stick 522 to change angle “A”. For example, support plate 532 may be connected to a tilting mechanism such as a tilt arm 534 and a joint 536 (e.g., a revolute joint permitting rotation about a single axis, a ball joint permitting rotation about two perpendicular axes, etc.). Tilting may be achieved with one or more suitable actuators (not shown).

If desired, inceptor assembly 500 may further be provided at a fixed inward angle or configured to tilt laterally inwards (e.g., towards an operator or inboard).

In adjustable configurations, the adjustment may be automated. For example, a controller 314 (FIG. 4) having one or more processors associated with aircraft 10 and configured to determine a yaw plane may receive a signal indicating an angle of travel of the aircraft or a flight type of the aircraft (e.g., whether the aircraft is in vertical flight, wingborne flight, or a transition between the two). The angle of travel may be determined from a pitch instrument such as an attitude indicator or via one or more gyroscopes, accelerometers, magnetometers, etc. The determined yaw plane may be translated to an angle of tilt for inceptor 500. Based on the determined angle of attack and/or flight type, one or more motors may alter angle “A” to an angle that matches the current state of aircraft 10 (e.g., by increasing angle “A” when in vertical flight or landing such that control stick 522 moves more vertically).

It will be apparent to persons skilled in the art that various modifications and variations can be made to the disclosed structure. While illustrative embodiments have been described herein, the scope of the present invention includes any and all embodiments having equivalent elements, modifications, omissions, combinations (e.g., of aspects across various embodiments), adaptations and/or alterations as would be appreciated by those skilled in the art based on the present invention. The limitations in the claims are to be interpreted broadly based on the language employed in the claims and not limited to examples described in the present specification or during the prosecution of the application, which examples are to be construed as non-exclusive. Further, the steps of the disclosed methods may be modified in any manner, including by reordering steps and/or inserting or deleting steps, without departing from the principles of the present invention. It is intended, therefore, that the specification and examples be considered as exemplary only, with a true scope and spirit of the present invention being indicated by the following claims and their full scope of equivalents.

What is claimed is:

1. An aircraft, comprising:
a first inceptor assembly having:
a first base; and
a first control stick extending away from the first base, the first control stick defining a first longitudinal axis that extends through the first control stick, the first longitudinal axis forming a non-zero angle with a vertical direction; and
a second inceptor assembly having:
a second base; and
a second control stick extending away from the second base, the second control stick defining a second longitudinal axis that extends through the second control stick and through the second base, the second longitudinal axis being generally aligned with a vertical direction.

2. The aircraft of claim 1, wherein the first inceptor assembly is for use with a left hand of an operator and the second inceptor assembly is for use with a right hand of the operator.

3. The aircraft of claim 1, wherein the aircraft is capable of vertical takeoff and landing.

4. The aircraft of claim 3, wherein the first inceptor assembly is configured for increasing or decreasing an altitude of the aircraft during takeoff and landing.

5. The aircraft of claim 3, wherein the first inceptor assembly is configured for increasing or decreasing an altitude of the aircraft during wing-borne flight.

6. The aircraft of claim 1, wherein the first longitudinal axis extends through a center of a hand-grip portion of the first control stick.

7. The aircraft of claim 1, wherein the non-zero angle of the first inceptor assembly is adjustable.

8. A system for controlling an aircraft, comprising:
a first inceptor assembly including a first control stick configured to receive a longitudinal input and a lateral input; and
a second inceptor assembly including a second control stick configured to receive a longitudinal input and a lateral input,
the first inceptor assembly being at a fixed orientation such that, when the first control stick and the second control stick are each at neutral positions, the first control stick forms an angle with respect to a vertical direction that is different than an angle that the second control stick forms with the vertical direction.

9. The system of claim 8, further including a hand-grip portion on the first control stick, a longitudinal axis extending through a center of the hand-grip portion, the first inceptor assembly being fixed at an orientation in which the longitudinal axis forms an angle of at least about 20 degrees and less than about 90 degrees with a vertical direction.

10. The system of claim 8, further including a hand-grip portion on the first control stick, a longitudinal axis extending through a center of the hand-grip portion, the first inceptor assembly being fixed at an orientation in which the longitudinal axis forms an angle with a vertical direction due to the first control stick extending forward and away from a seat for an operator of the aircraft.

11. The system of claim 8, further including a controller configured to translate a lateral input of the first control stick to a yaw control of the aircraft and a longitudinal input of the first control stick to a vertical control of the aircraft.

12. The system of claim 11, wherein the controller is configured to translate a lateral input of the second control stick to a lateral translation of the aircraft and to translate a longitudinal input of the first control stick to a forward or rearward translation of the aircraft.

13. The system of claim 8, wherein a hand-grip portion of the second control stick 14. A method of controlling an aircraft, comprising:
receiving a first longitudinal input via a first inceptor assembly;
actuating one or more control surfaces and/or one or more rotors to control a vertical movement of the aircraft in response to the first longitudinal input;
receiving a first lateral input from via first inceptor assembly;
actuating the one or more control surfaces and/or the one or more rotors to control a yaw rotation of the aircraft in response to the first lateral input;
receiving a second longitudinal input from a second inceptor assembly; and
actuating the one or more control surfaces and/or the one or more rotors to control a movement of the aircraft in response to the second longitudinal input,
the first longitudinal input being generated when a first control stick of the first inceptor assembly is pushed forward and downward or pulled backward and upward.

15. The method of claim 14, wherein the second longitudinal input is generated with a second control stick of a second inceptor.

16. The method of claim 15, wherein the second longitudinal input is generated without pushing the second control stick downward and without pulling the second control stick upward.

17. The method of claim 14, wherein the movement of the aircraft in response to the second longitudinal input is forward translation or rearward translation.

18. The method of claim 14, further including:
receiving a second lateral input via the second inceptor assembly; and
actuating the one or more control surfaces and/or the one or more rotors to control lateral translation of the aircraft in response to the second lateral input.

19. The method of claim 14, wherein the first longitudinal input, first lateral input, and second longitudinal input are received during takeoff or landing.

20. The method of claim 14, wherein the first longitudinal input, first lateral input, and second longitudinal input are received during wing-borne flight.
